(19) United States
(12) Patent Application Publication
(10) Pub. No.: US 2009/0192682 A1
(43) Pub. Date: Jul. 30, 2009

(54) Operator enclosure including movable top and machine using same

(75) Inventors: Biagio Ciarla, Appleton, WI (US); Eddie Janszen, Toluca, IL (US)

Correspondence Address: CATERPILLAR c/o LIELL, MCNEIL & HARPER;Intellectual Property Department, AH9510, 100 N.E. Adams, Peoria, IL, 61629-9510, US

(73) Assignee: Caterpillar Inc.

(21) Appl. No.: 12/011,867

(22) Filed: Jan. 30, 2008

(51) Int. Cl. G06F 17/00

(52) U.S. Cl. 701/49; 296/190.11

(57) ABSTRACT

A machine includes an operator enclosure mounted on a machine frame. The operator enclosure includes at least first and second sides, a top, and a front access door. An operator floor space of the machine is located between the front access door and an operator seat of the machine. The top is movable between a closed position where the operator floor space is covered and an open position where the operator floor space is uncovered.

### TECHNICAL FIELD

The present disclosure relates generally to a movable top of an operator enclosure of a machine, and more particularly to a top that is movable between an open position and a closed position in response to a change in position of a front access door.

### BACKGROUND

Skid steer loaders are relatively compact, low profile machines that offer high maneuverability and enable operation in relatively small areas. They typically include an operator seat oriented in a position providing a view immediately in front of the skid steer. Also typical of skid steer designs is the location of the lift arms for carrying and lifting a material handling bucket or other implement. The arms typically extend longitudinally on both sides of and immediately adjacent the operator seat. An operator enclosure, therefore, is typically provided to ensure against an operator inadvertently extending a hand or limb to the side and into the path of the lift arms. Due to the location of the lift arms, the operator enclosure is typically entered from the front of the machine, across the bucket or other implement that is carried by the lift arms.

Due to the small size and low profile design of skid steer loaders and, as a result, the operator enclosures thereof, operators may encounter problems during ingress and egress. For example, an operator may be required to crouch when entering the operator enclosure, pivot to a forward facing position while remaining crouched, and then sit in the operator seat. To leave the operator enclosure, the operator may be required to exit the operator seat while crouching, pivot to a position facing the operator seat while remaining crouched, and then back out of the operator enclosure. For all operators, and especially for taller operators, there is a significant risk of head contusions when entering or leaving the operator enclosure in this required fashion.

An alternative operator enclosure design for skid steer loaders is disclosed in U.S. Pat. No. 4,705,449. This reference teaches a skid steer having a lift arm design that permits the operator to enter and leave the skid steer through left and right access openings, rather than through a front access opening. Specifically, the lift arms are pivotably attached at a rear portion of the machine and include connecting members that extend above the operator enclosure, thus defining a side ingress and egress path. This reference, however, does not contemplate issues associated with entering and leaving a compact operator enclosure designed for a low profile machine, such as a skid steer loader. One specific concern may include operators inadvertently bumping their heads on a low top or roof of the operator enclosure during ingress and egress.

The present disclosure is directed to one or more of the problems set forth above.

### SUMMARY OF THE DISCLOSURE

In one aspect, a machine includes an operator enclosure mounted on a machine frame. The operator enclosure includes at least first and second sides, a top, and a front access door. An operator floor space of the machine is located between the front access door and an operator seat of the machine. The top is movable between a closed position where the operator floor space is covered and an open position where the operator floor space is uncovered.

In another aspect, an operator enclosure subassembly includes at least first and second side panels, a roof panel, and a front access door. A pair of spaced apart and parallel guide rails define a retraction path. The roof panel is at least partially supported by the guide rails and is movable between a closed position and an open position along the retraction path. A drive unit moves the roof panel between the open position and the closed position.

In yet another aspect, a method of moving a movable roof panel of an operator enclosure of a machine between a closed position and an open position includes a step of receiving a door position signal from a door position sensor. A change in position of a front access door of the operator enclosure is determined based on the door position signal. A drive unit is configured to move the movable roof panel between the closed position and the open position in response to the change in position of the front access door.

### BRIEF DESCRIPTION OF THE DRAWINGS

FIG. 1 is a perspective diagrammatic view of a machine having an operator enclosure, wherein a top of the operator enclosure is shown in a closed position, according to one embodiment of the present disclosure;

FIG. 2 is a perspective diagrammatic view of the machine of FIG. 1, wherein the top of the operator enclosure is shown in an open position;

FIG. 3 is a simplified block diagram of a drive unit for moving the top of the operator enclosure between the closed position of FIG. 1 and the open position of FIG. 2;

FIG. 4 is a perspective diagrammatic view of a machine having an operator enclosure according to another embodiment;

FIG. 5 is a side diagrammatic view of a machine having an operator enclosure according to another embodiment;

FIG. 6 is a perspective diagrammatic view of a machine having an operator enclosure according to yet another embodiment; and

FIG. 7 is a flow chart of one embodiment of a method of moving a movable roof panel of an operator enclosure of a machine between closed and open positions according to the present disclosure.

### DETAILED DESCRIPTION

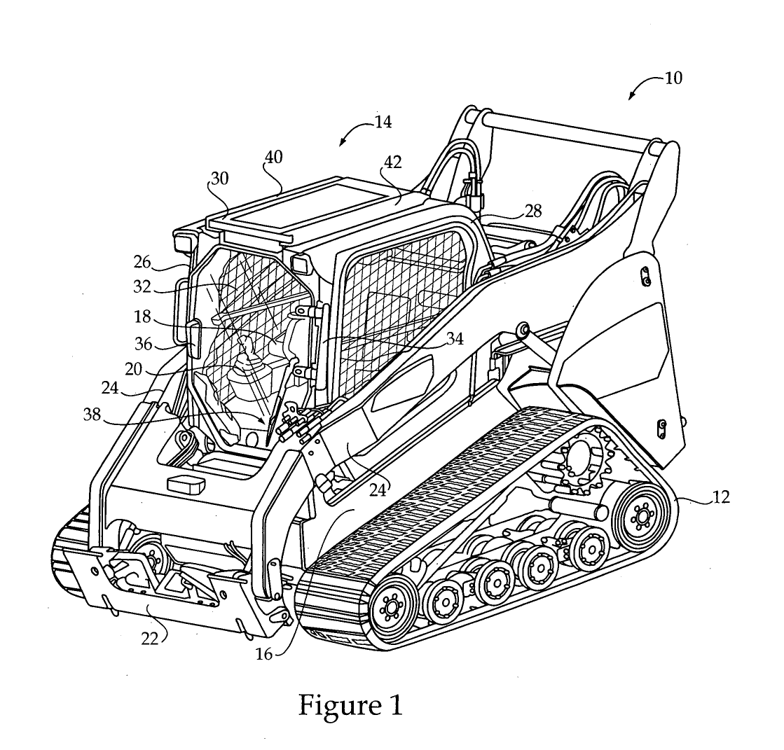

An exemplary embodiment of a machine 10 is shown generally in FIG. 1. The machine 10 may be a tracked skid steer loader, also referred to as a multi-terrain loader, as shown, having a tracked undercarriage 12. Alternatively, however, the machine 10 may be propelled by wheels, such as independently driven wheels positioned on opposite sides of the machine 10. According to one embodiment, such wheels may be driven at different speeds and in different directions for improved maneuverability of the machine 10. It should be appreciated, however, that machine 10 may include any machine or vehicle having an operator enclosure 14.

The operator enclosure 14 may be mounted to a machine frame 16 of the machine 10, and may include an operator seat 18 and various other devices, including, but not limited to, one or more machine operation controllers, such as operation controller 20. According to one embodiment, operation controller 20 may control operation of a machine implement, such as a bucket (not shown), that may be mounted on a loader arm assembly 22. The loader arm assembly 22, it should be appreciated, may include a pair of loader arms 24 pivotably attached to the machine 10 and extending longitudinally on both sides of the operator enclosure 14. According to another embodiment, operation controller 20 may include a directional controller that is movable to indicate one of various gear positions of the machine 10, such as forward, neutral, and reverse.

The operator enclosure 14 typically includes at least first and second sides 26 and 28, respectively, a top 30, and a front access door 32. The front access door 32, it should be appreciated, is positioned at a front portion of the machine 10 and is movable between a closed position (as shown) and an open position. The front access door 32 may include a hinged connection 34 to the operator enclosure 14 or may be otherwise attached. Movement between the closed and open positions may be facilitated, according to one embodiment, by actuation of a manual actuation device 36 of the front access door 32.

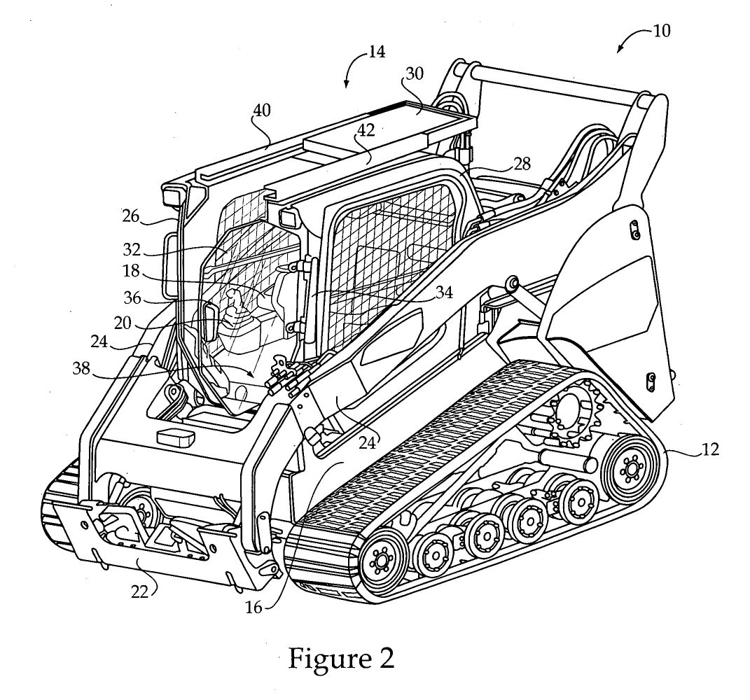

The machine 10 also includes an operator floor space 38 positioned generally between the front access door 32 and the operator seat 18. The operator floor space 38 may be, at least partially, enclosed by the operator enclosure 14. The top 30, which may include a planar roof panel, is movable between a closed position (as shown) and an open position. It should be appreciated that the operator floor space 38 is covered by the movable top 30 while the top 30 is in a closed position, as shown in FIG. 1, and uncovered when the top 30 is in an open position, as shown in FIG. 2.

Referring to both FIGS. 1 and 2, the operator enclosure 14 may include a pair of spaced apart and parallel guide rails 40 and 42 that define a retraction path. The guide rails 40 and 42 may be horizontally aligned, as shown, and may be supported on top portions of the first and second sides 26 and 28 of the operator enclosure 14. According to one embodiment, the first and second sides 26 and 28 may include vertically aligned and planar side panels that are horizontally spaced from one another, as shown. The top 30 is at least partially supported by the spaced apart and parallel guide rails 40 and 42 and is movable along the retraction path defined by the guide rails 40 and 42.

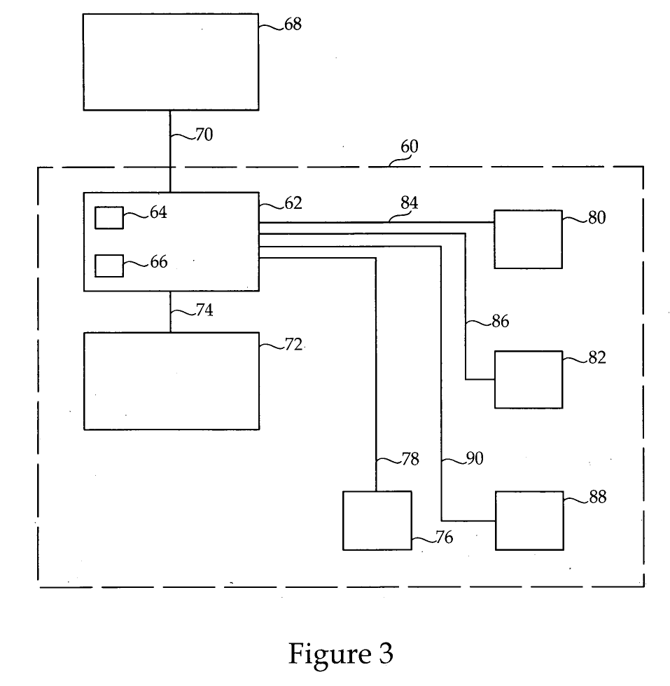

A variety of different mechanisms may be employed to move the top 30 of the operator enclosure 14 between the closed position (of FIG. 1) and the open position (of FIG. 2). According to one embodiment, a manual actuation device (not shown) may be used to move the top 30 along the retraction path defined by the guide rails 40 and 42. According to another embodiment, the movable top 30 may be moved using an automatic actuation device, such as an electric, hydraulic, pneumatic, or magnetic device, coupled to the top 30 and activated via a button or switch. According to yet another embodiment, a drive unit 60, shown generally in FIG. 3, may be used to move the top 30 between the open and closed positions.

The drive unit 60 may include an electronic controller 62 for controlling and monitoring operation of the movable top 30. The electronic controller 62 may be of standard design and includes a processor 64, such as, for example, a central processing unit (CPU), a memory 66, and an input/output circuit that facilitates communication internal and external to the electronic controller 62. The processor 64 controls operation of the electronic controller 62 by executing operating instructions, such as, for example, computer readable program code stored in memory, wherein operations may be initiated internally or externally to the electronic controller 62. A control scheme may be utilized that monitors outputs of systems or devices, such as, for example, sensors, actuators, or control units, via the input/output circuit to control inputs to various other systems or devices.

The memory 66 may comprise temporary storage areas, such as, for example, cache, virtual memory, or random access memory (RAM), or permanent storage areas, such as, for example, read-only memory (ROM), removable drives, network/internet storage, hard drives, flash memory, memory sticks, or any other known volatile or non-volatile data storage devices located internally or externally to the electronic controller 62. One skilled in the art will appreciate that any computer-based system utilizing similar components is suitable for use with the present disclosure.

It should be appreciated that one or more additional controllers, such as, for example, an engine controller and a hydraulic system controller, may be provided for controlling or monitoring respective aspects of the machine 10. According to one embodiment, the machine 10 may further include a main machine electronic controller 68 for controlling and monitoring the various other controllers employed by the machine 10. Specifically, the main machine electronic controller 68 may be in communication with electronic controller 62 via a communications line 70. The communications line 70, and other communications lines used herein, may include any known wired or wireless means for communication.

The electronic controller 62 may be configured to selectively energize and deenergize an electric motor 72. The electric motor 72, according to one embodiment, may include a bi-directional electric motor for moving the movable top 30 between the closed and open positions. It should be appreciated that the electric motor 72 may provide power to any gear or structure that is capable of translating that power into linear movement of the movable top 30 along the retraction path. Although an electric motor is described, it should be appreciated that an alternative power source may be used, including, for example, a hydraulic or pneumatic drive unit.

According to one embodiment, the electronic controller 62 may be configured to energize the electric motor 72, via a communications line 74, in response to a door position signal from a door position sensor 76. Specifically, the door position sensor 76 may be configured to detect a change in position of the front access door 32 and transmit that change in position to the electronic controller 62 via a communications line 78. As should be appreciated, the door position sensor 76 may include any known sensor or switch for detecting a change in position of the front access door 32, and may be positioned accordingly. According to one embodiment, the electronic controller 62 may be configured to energize the electric motor 72 to move the movable top 30 to the open position (FIG. 2) in response to a door position change from the closed position to the open position, as shown in FIG. 2. Further, the electronic controller 62 may be configured to energize the electric motor 72 to move the movable top 30 to the closed position (FIG. 1) in response to a door position change from the open position to the closed position, as shown in FIG. 1.

The machine 10 may further include a first roof sensor 80 and a second roof sensor 82. According to one embodiment, the electronic controller 62 may be configured to deenergize the electric motor 72, via communications line 74, in response to a roof position signal from one of the first and second roof sensors 80 and 82. Specifically, the first roof sensor 80 may be configured to detect a fully open position of the movable top 30, as shown in FIG. 2, and transmit that information to the electronic controller 62 via a communications line 84.

The second roof sensor 82 may be configured to detect a fully closed position of the movable top 30, as shown in FIG. 1, and transmit that position information to the electronic controller 62 via a communications line 86. It should be appreciated that each of the first and second roof sensors 80 and 82 may include an appropriate sensor or switch for detecting positions of the movable top 30. According to one embodiment, the electronic controller 62 may be configured to deenergize the electric motor 72 in response to either of a fully open position (FIG. 2) or a fully closed position (FIG. 1) of the movable top 30, as detected by the first and second roof sensors 80 and 82.

At least one proximity sensor 88 may also be provided for use with the operator enclosure 14. According to one embodiment, the electronic controller 62 may be configured to deenergize the electric motor 72 in response to an obstruction signal from the proximity sensor 88. Specifically, the proximity sensor 88 may be positioned and configured to detect an obstruction along the retraction path of the movable top 30 and transmit that information to the electronic controller 62 via a communications line 90. Such an obstruction may include, for example, a hand or limb of the operator or other object that may become positioned along the retraction path during normal operation of the machine 10.

It should be appreciated that additional sensors, such as sensors that detect whether the operator seat 18 is occupied may be used with the present disclosure. According to one embodiment, the electronic controller 62 may be configured to prevent activation of the electric motor 72, or even operation of the machine 10, unless the operator is occupying the operator seat 18. Additional sensors, and the sensors 76, 80, 82, and 88 described herein, may be based on any of a variety of different sensing technologies, such as, for example, mechanical, electrical, magnetic, and optical sensing devices.

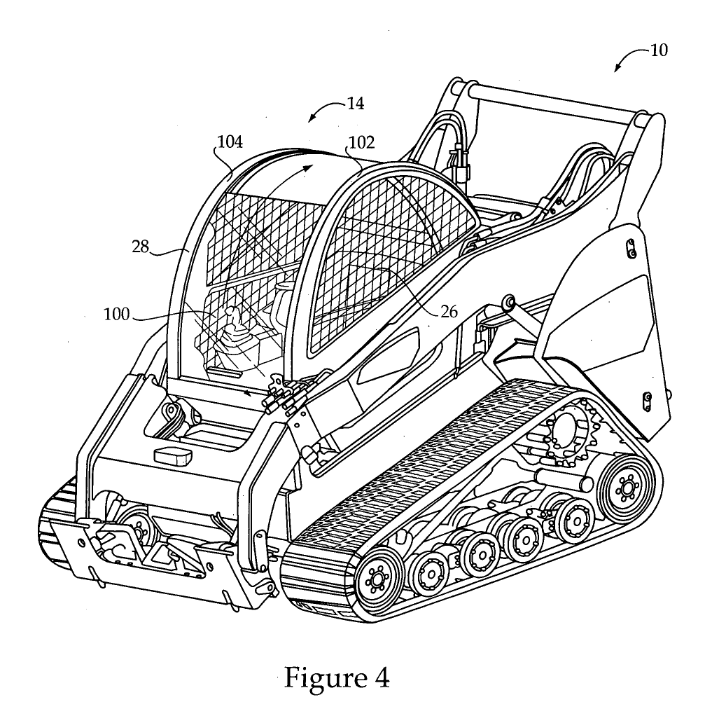

Turning now to FIG. 4, an alternative embodiment of the operator enclosure 14 is shown. The operator enclosure 14 may include first and second sides 26 and 28, similar to the previous embodiment; however, the top and front access door, according to this embodiment, may include one integral panel 100. The integral panel 100 may be curved, as shown, and may be movable along a retraction path defined by a pair of spaced apart and curved guide rails 100 and 102. Specifically, the integral panel 100 may be, at least partially, supported by the curved guide rails 100 and 102 and movable between closed and open positions using any of the means described above.

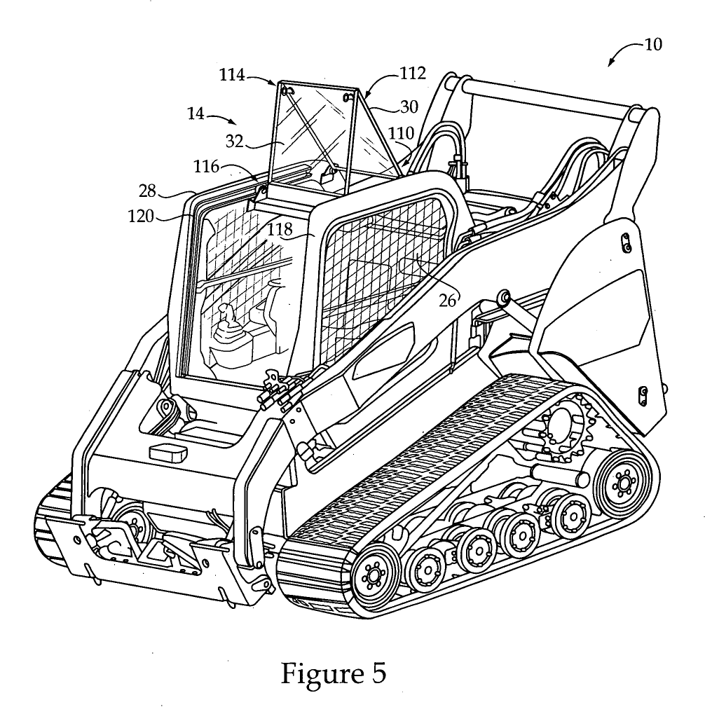

Another embodiment of operator enclosure 14 is shown generally in FIG. 5. The operator enclosure 14 may include first and second sides 26 and 28, similar to the embodiment of FIGS. 1 and 2, and may further include top 30 and front access door 32. However, the top 30 of this embodiment includes a roof panel having a first end 110 pivotably attached to the machine 10 and a second end 112 pivotably attached to a first end 114 of the front access door 32. A second end 116 of the front access door 32 is at least partially supported by a pair of spaced apart guide rails 118 and 120, which define a vertical path and a horizontal path. Further, the second end 116 of the front access door 32 is movable along both of the vertical and horizontal paths to provide open and closed positions of both of the front access door 32 and the top 30.

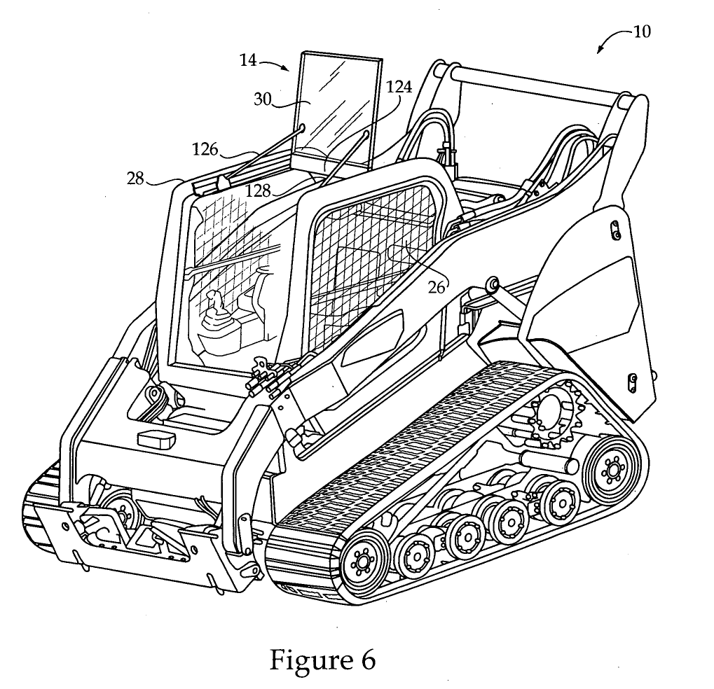

Yet another embodiment of operator enclosure 14 is shown in FIG. 6. The operator enclosure 14 is shown with front access door 32 removed and may include first and second sides 26 and 28, similar to the embodiment of FIGS. 1 and 2. The top 30, according to this embodiment, may be pivotably attached to the machine 10 at a first end 124 thereof and may be movable with the aid of springs 126 and 128, which may, for example, include gas springs.

It should be appreciated that any of the embodiments described herein may incorporate locking mechanisms for securing the movable top 30 at one of the open and closed positions. According to one embodiment, the manual actuation device 36 of the front access door 32 may include a keyed lock having a locked position. It may, therefore, be desirable to prevent activation of the electric motor 72 when the keyed lock is in the locked position. It should also be appreciated that any of the first and second sides 26 and 28, top 30, and front access door 32 may include a transparent, or translucent, material to ensure adequate operator visibility.

### INDUSTRIAL APPLICABILITY

The operator enclosure and movable top thereof, according to the present disclosure, may find application in a variety of on-highway or off-highway machines having operator enclosures. Although a tracked skid steer loader is depicted, it should be appreciated that the operator enclosure, as described herein, may be used with wheel loaders, articulated trucks, or various other types of construction, mining, and agricultural machines. However, the operator enclosure may find specific use with operator enclosures having a front access door, and may be even more specifically applicable to such operator enclosures of compact, low profile machines.

Referring to FIGS. 1-7, an exemplary embodiment of a machine 10, such as a tracked skid steer loader, includes an operator enclosure 14 mounted to a machine frame 16. The operator enclosure 14 may include an operator seat 18 and various other devices, including, but not limited to, one or more machine operation controllers, such as operation controller 20. The operator enclosure 14, according to one embodiment, includes first and second side panels 26 and 28, a movable roof panel 30, a front access door 32, and an operator floor space 38 positioned generally between the front access door 32 and the operator seat 18.

The operator enclosure 14 may further include a pair of spaced apart and parallel guide rails 40 and 42 that define a retraction path, such as a horizontal retraction path. The movable roof panel 30 may be, at least partially, supported by the guide rails 40 and 42 and movable between open and closed positions along the retraction path. It should be appreciated that the operator floor space 38 is covered by the movable top 30 while it is in a closed position, as shown in FIG. 1, and uncovered when the top 30 is in an open position, as shown in FIG. 2.

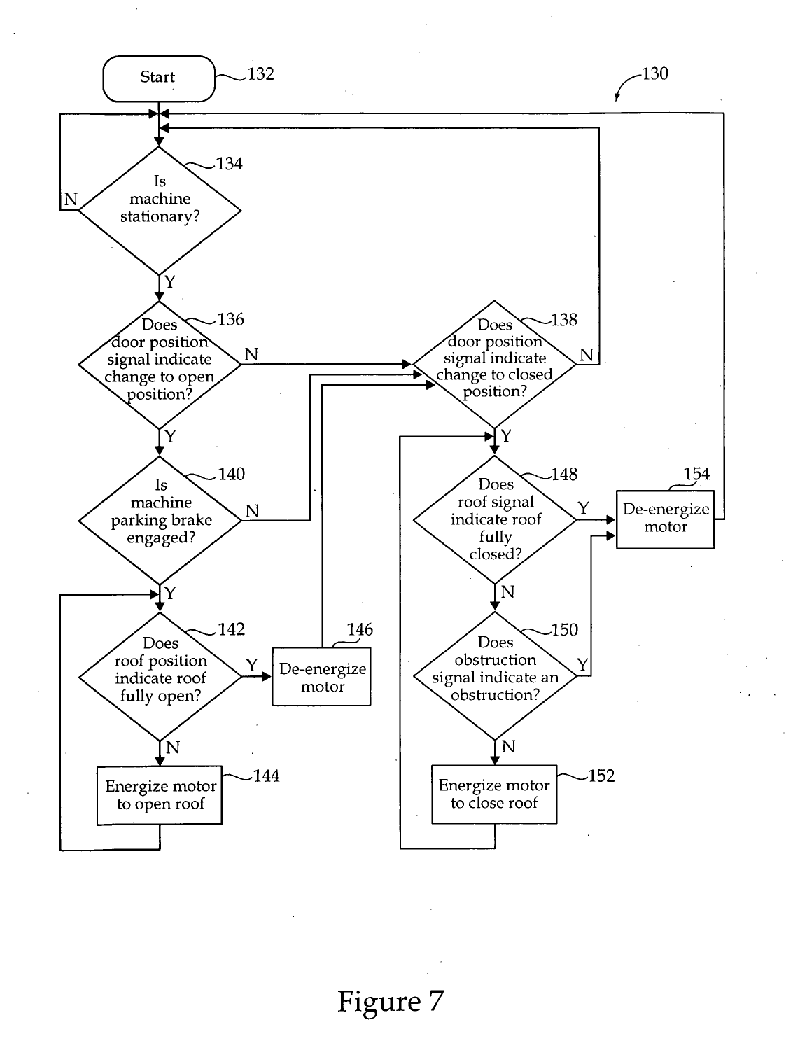

Utilizing the movable top 30 and method according to the present disclosure may help improve operator ingress and egress relative to low profile machines. Turning to FIG. 7, there is shown a flow chart 130 representing an exemplary method of moving the movable roof panel 30 of the operator enclosure 14 of machine 10. The method may be implemented in whole, or in part, by the electronic controller 62 of drive unit 60. The electronic controller 62 may include a computer usable medium having computer readable code thereon for implementing the method. The method may run continuously or may be selectively activated or deactivated, as necessary.

The method begins at a START, Box 132. From Box 132, the method proceeds to Box 134, which includes the step of determining if the machine 10 is stationary. For example, it may only be desirable to perform the following method steps if the machine 10 is in a stationary position. The electronic controller 62 may, according to one embodiment, receive this information from the main machine electronic controller 68, although numerous methods for acquiring this information are contemplated. If the machine 10 is stationary, the method proceeds to Box 136. Otherwise, the machine 10 may continuously await a positive determination before proceeding with the method.

At Box 136, the method determines if a door position signal from the door position sensor 76 indicates a change in position of the front access door 32, such as a change in position caused by an operator opening or closing the front access door 32. Specifically, the electronic controller 62 may determine, based on the door position signal, whether the front access door 32 has changed from a closed position to an open position. If it is determined at Box 136 that the front access door 32 has not changed from a closed position to an open position, the method proceeds to Box 138. However, if the electronic controller 62 determines the front access door 32 has changed from a closed position to an open position, as shown in FIG. 2, the method proceeds to Box 140.

At Box 140, the method determines if a parking brake of the machine 10 is engaged. According to some embodiments, it may be desirable include checks that prevent movement of the movable roof panel 30 unless specific requirements are satisfied. Therefore, according to one embodiment, the method proceeds to Box 142 only if the parking brake of the machine 10 is engaged. It should be appreciated that other requirements may be implemented instead of or in addition to this exemplary requirement. If the parking brake is not engaged, the method proceeds to Box 138.

At Box 142, the method determines if a roof position signal from a first roof position sensor 80 indicates a fully open position of the movable roof panel 30. The method may continually energize the electric motor 72, at Box 144, unless or until a fully open position of the movable roof panel 30 is indicated. Once the fully open position is detected, the method proceeds to Box 146, which includes a step of deenergizing the electric motor 72.

At Box 138, the method determines if the door position signal from the door position sensor 76 indicates a change in position of the front access door 32 from an open position to a closed position, as shown in FIG. 1. If it is determined at Box 138 that the front access door 32 has not changed from a closed position to an open position, the method returns to Box 134. However, if the electronic controller 62 determines the front access door 32 has changed from a closed position to an open position, the method proceeds to Box 148.

At Box 148, the method may determine if a roof position signal from a second roof position sensor 82 indicates a fully closed position of the movable roof panel 30. The method may continue to energize the electric motor 72, at Box 152, unless or until either a fully open position of the movable roof panel 30 is indicated, at Box 148, or an obstruction along the retraction path is detected by a proximity sensor 88, at Box 150. Once the fully closed position is detected, or an obstruction is detected, the method proceeds to Box 154, which includes a step of deenergizing the electric motor 72. According to one embodiment, it may desirable to provide logic within the method that will prevent operation of the machine 10 until a detected obstruction is removed from the retraction path and the movable roof panel 30 is fully closed. It should be appreciated that the disclosed method is exemplary, and that additional method steps may be used instead of or in addition to any of the method steps described herein.

The operator enclosure 14 and movable top 30 thereof, according to the present disclosure, provide an improved means of ingress and egress, particularly for low profile machines, that requires minimal additional clearance above the machine 10. Specifically, operation of the movable top 30, as described herein, may help prevent operators from inadvertently bumping their heads on the top 30 when entering or exiting the machine. According to one embodiment, the operator may first open the front access door 32, causing the movable top 30 to move to the open position. The operator may then step onto the operator floor space 38 while standing erect, pivot to a forward facing position without crouching, and then sit in the operator seat 18. The movable top 30 may return to the closed position upon closing of the front access door 32.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A machine, comprising:
a machine frame;
an operator enclosure mounted on the machine frame and including at least first and second sides, a top, and a front access door;
an operator floor space of the machine located between the front access door and an operator seat of the machine; and
wherein the top is movable between a closed position wherein the operator floor space is covered and an open position wherein the operator floor space is uncovered.

2. The machine of claim 1, wherein the operator enclosure further includes a pair of spaced apart and parallel guide rails defining a retraction path; and wherein the top includes a planar roof panel at least partially supported by the guide rails and movable along the retraction path.

3. The machine of claim 2, wherein the first side includes a first vertically aligned and planar side panel, and the second side includes a second vertically aligned and planar side panel horizontally spaced from the first side panel; and wherein the spaced apart guide rails are supported on the first and second side panels.

4. The machine of claim 3, further including a drive unit for moving the roof panel between the open position and the closed position, wherein the drive unit includes at least an electric motor and an electronic controller.

5. The machine of claim 4, further including a door position sensor, wherein the electronic controller is configured to energize the electric motor in response to a door position signal from the door position sensor.

6. The machine of claim 5, further including a first roof position sensor and a second roof position sensor, wherein the electronic controller is further configured to deenergize the electric motor in response to a roof position signal from one of the first and second sensors.

7. The machine of claim 6, further including at least one proximity sensor for sensing an obstruction along the retraction path, wherein the electronic controller is further configured to deenergize the electric motor in response to an obstruction signal from the proximity sensor.

8. The machine of claim 1, wherein the operator enclosure further includes a pair of spaced apart and curved guide rails defining a curved path; and wherein the top and the front access door are at least partially supported by the guide rails and movable along the curved path.

9. The machine of claim 1, further including a pair of spaced apart guide rails defining a vertical path and a horizontal path, wherein the top includes a roof panel having a first end pivotably attached to the machine and a second end pivotably attached to a first end of the front access door, and wherein a second end of the front access door is at least partially support by the guide rails and movable along the vertical path and the horizontal path.

10. The machine of claim 1, wherein the top includes a roof panel pivotably attached to the machine at a first end thereof.

11. An operator enclosure subassembly, comprising:
at least first and second side panels, a roof panel, and a front access door;
a pair of spaced apart and parallel guide rails defining a retraction path, wherein the roof panel is at least partially supported by the guide rails and movable between a closed position and an open position along the retraction path; and
a drive unit for moving the roof panel between the open position and the closed position.

12. The operator enclosure subassembly of claim 11, further including a door position sensor, wherein an electronic controller is configured to energize an electric motor in response to a door position signal from the door position sensor.

13. The operator enclosure subassembly of claim 12, further including a first roof position sensor and a second roof position sensor, wherein the electronic controller is further configured to deenergize the electric motor in response to a roof position signal from one of the first and second sensors.

14. The operator enclosure subassembly of claim 13, further including at least one proximity sensor for sensing an obstruction along the retraction path, wherein the electronic controller is further configured to deenergize the electric motor in response to an obstruction signal from the proximity sensor.

15. A method of moving a movable roof panel of an operator enclosure of a machine between a closed position and an open position, comprising:
receiving a door position signal from a door position sensor;
determining a change in position of a front access door of the operator enclosure based on the door position signal; and
energizing a drive unit configured to move the movable roof panel between the closed position and the open position in response to the change in position of the front access door.

16. The method of claim 15, wherein the energizing step includes:
energizing an electric motor to move the movable roof panel to the open position in response to a change in position of the front access door from a door closed position to a door open position; and
energizing the electric motor to move the movable roof panel to the closed position in response to a change in position of the front access door from the door open position to the door closed position.

17. The method of claim 16, wherein the energizing step further includes:
receiving a roof position signal from at least one of a first roof position sensor and a second roof position sensor;
determining a roof position based on the roof position signal; and
deenergizing the electric motor in response to one of a fully closed roof position and a fully open roof position.

18. The method of claim 17, wherein the energizing step further includes:
receiving an obstruction signal from at least one proximity sensor;
determining a presence of an obstruction along a path of the movable roof panel based on the obstruction signal; and
deenergizing the electric motor in response to the presence of the obstruction.

19. The method of claim 15, further including:
determining a speed of the machine; and
moving the movable roof panel between the closed position and the open position only if the speed of the machine is zero.

20. The method of claim 15, further including:
detecting a rollover condition of the machine; and
energizing the electric motor to move the movable roof panel to the open position in response to the rollover condition.
